(19) United States
(12) Patent Application Publication
(10) Pub. No.: US 2009/0044463 A1
(43) Pub. Date: Feb. 19, 2009

(54) Adjustable shim

(76) Inventors: Onorio Moscone, Washington, MI (US); Robert A. Walz, Shelby Township, MI (US)

Correspondence Address: WARN, HOFFMANN, MILLER & LALONE, .P.C, PO BOX 70098, ROCHESTER HILLS, MI, 48307, US

(21) Appl. No.: 11/893,545

(22) Filed: Aug. 16, 2007

(51) Int. Cl. F16B 2/14

(52) U.S. Cl. 52/126.1

(57) ABSTRACT

The present invention is at least one spacer selectively connected to an end spacer by a backing portion, where the at least one spacer is removed from the end spacer by severing the backing portion.

### FIELD OF THE INVENTION

The present invention relates to the positioning of a frame used for a door or window or other opening where fitting is required. More particularly, the present invention is a spacer device which is used for aligning the frame of a door or window relative to a building, such that the door or window frame is aligned properly.

### BACKGROUND OF THE INVENTION

Shim or spacers are commonly used with devices such as window frames and door frames during the construction or remodeling of a building to provide the proper positioning of the window or door frame. Doors, windows, and the like are usually manufactured to a pre-specified shape. During the construction of a building, the frame which supports the door or window must be within a specified tolerance to match the shape of the window or the door such that when the door or window is installed, the door or window will be aligned and operate properly.

During the construction of a building, the walls will often have openings which are prefabricated and used for the insertion of a door or window frame. Often times, these openings in the wall of the building do not have precise dimensions, or are not aligned properly. When the door or window frame is placed into the opening, often times spacers or shims are used to provide proper alignment, as well as position the door or window frame in the opening in the wall. However, due to variances in manufacturing of the wall, the opening in the wall can often have dimensions that are inconsistent, which does not facilitate the use of a single type of spacer or shim.

Accordingly, there exists a need for a spacer or shim which can compensate for different manufacturing tolerances in the wall of a building which has an opening used for the construction of a door frame or window frame.

### SUMMARY OF THE INVENTION

The present invention is at least one spacer selectively connected to an end spacer by a backing portion, where the at least one spacer is removed from the end spacer by severing the backing portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a first perspective view of a spacer device used in a door frame or window frame, according to the present invention;

FIG. 2 is a front view of a door frame placed inside an opening in a wall, located in a desired position using a spacer device, according to the present invention;

FIG. 3 is a second perspective view of a spacer device, with a first spacer and a portion of the middle spacers folded upward, according to the present invention;

FIG. 4 is a side view of a spacer device having an adhesive backing portion for holding the spacers together, according to the present invention;

FIG. 5 is a side view of a spacer device that has been die-cut, according to the present invention;

FIG. 6 is a side view of a spacer device having an alternate embodiment of a backing portion for holding the spacers together, according to the present invention; and

FIG. 7 is a side view of a spacer device having a second alternate embodiment of a backing portion for holding the spacers together, according to the present invention.

### DETAILED DESCRIPTION OF THE PREFERRED EMBODIMENTS

The following description of the preferred embodiment(s) is merely exemplary in nature and is in no way intended to limit the invention, its application, or uses.

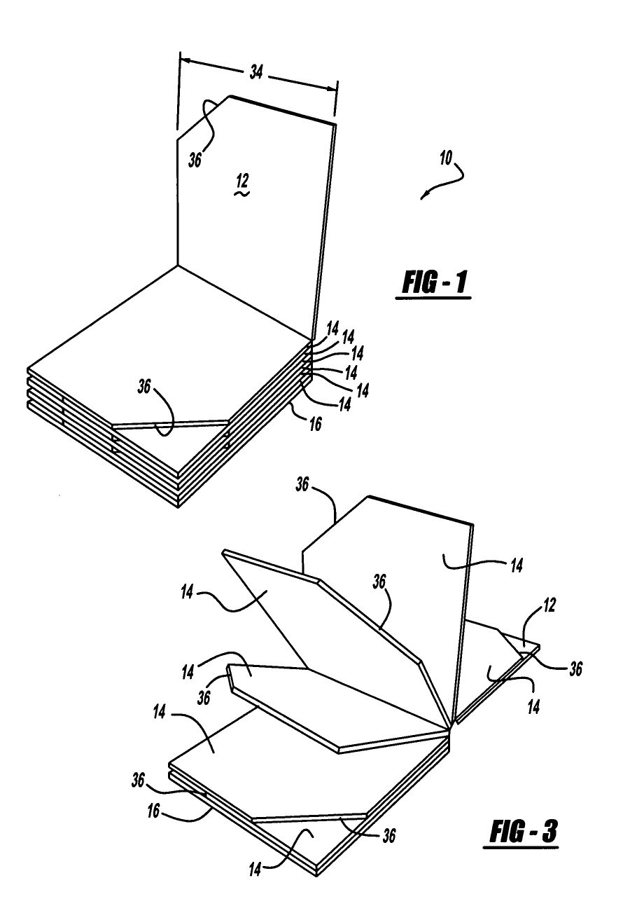

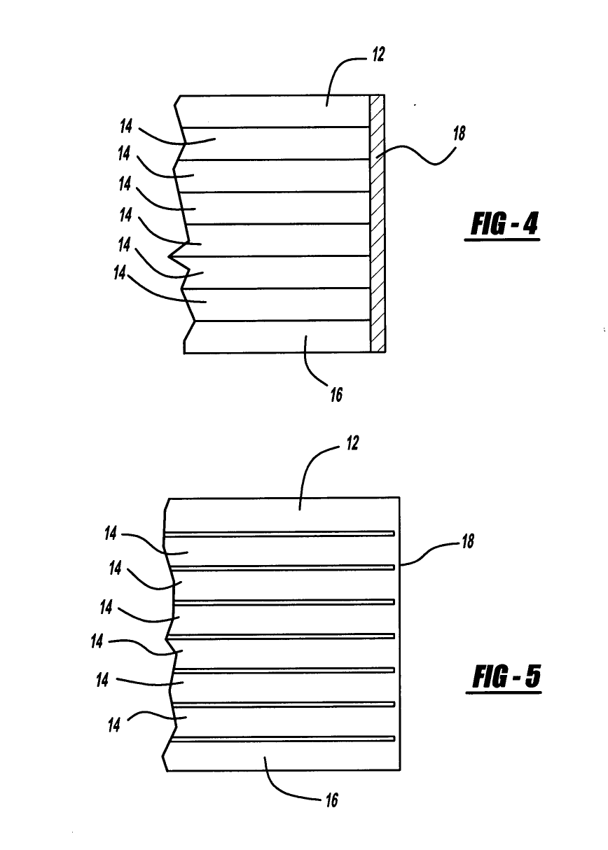

Referring to FIGS. 1-3, a spacer device according to the present invention is shown generally at 10. The spacer device 10 includes a first spacer 12, a group of middle spacers 14, and an end spacer 16. The middle spacers 14 are located between the first spacer 12 and the end spacer 16. The spacer device 10 also includes a backing portion 18. The backing portion 18 holds the spacers 12, 14, 16 together. The backing portion 18 is an adhesive or bonding agent attaching the end of each spacer 12, 14, 16, as shown in FIGS. 4, 6, and 7. However, the spacers 12, 14, 16 could be die-cut leaving the ends attached such that individual spacers 12, 14, 16 can be removed from the structure, as shown in FIG. 5. Other structures which allow the spacers 12, 14, 16 to be removably connected to one another are within the scope of the present invention.

In a preferred embodiment the backing portion 18 is an adhesive for holding the first spacer 12, middle spacers 14, and end spacer 16 in a stacked configuration as shown in FIGS. 1, 3, 4, 6, and 7. The spacers 12, 14, 16 are selected to be of a suitable rigidity and composition to provide structural integrity for allowing a fastener to be driven through without destroying the spacers 12, 14, 16. Preferably, the thickness of the spacers 12, 14, 16 is about one-eighth of an inch. However, the thickness of the spacers 12, 14, 16 can range from about one-sixteenth of an inch, to one-quarter of an inch. While each spacer 12, 14, 16 is shown bearing an equal thickness, the thickness may be varied depending on the desired application. If the backing portion 18 is an adhesive, the backing portion will hold the spacers 12, 14, 16 such that one or more of the spacers 12, 14, 16 can be “peeled away.”

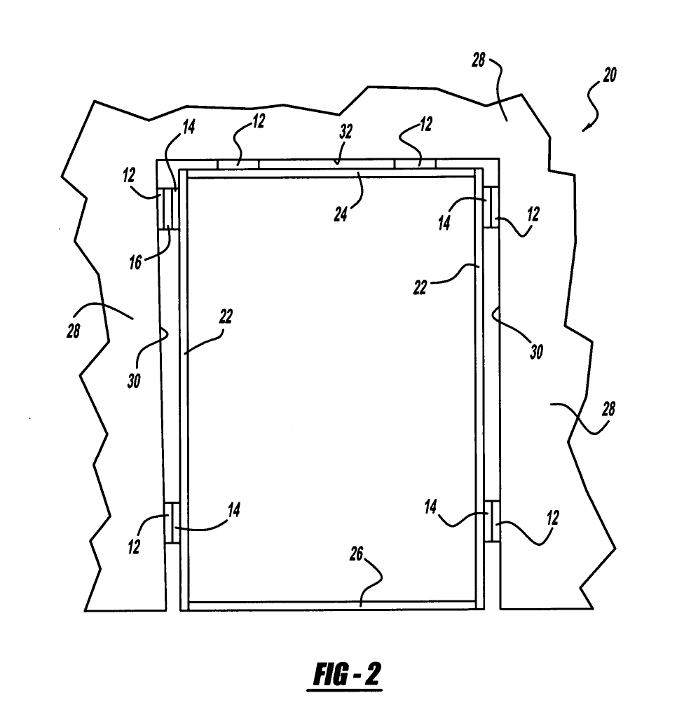

The spacer device 10 can be used for various applications for aligning different components. For instance, the spacer device 10 can be used for aligning a frame 20 of a doorway, generally shown in FIG. 2. In this embodiment, frame 20 is rectangular in shape, and includes two side frame members 22, an upper frame member 24, and a lower frame member 26, which are located in an open portion in a structure such as a wall 28. During the construction of a building, or other structure, an open portion of a wall, similar to the wall 28 shown in FIG. 2, there are situations where the sides, shown at 30, of the wall are not perpendicular to the ground, or the top 32 of the wall 28, is not parallel to the ground. A doorway constructed in this situation would lead to the frame 20 looking uneven. The spacer device 10 of the present invention is used to provide for the construction of a door frame 20 where the sides 30 are not perpendicular with the ground or floor of a building, or the top 32 is not parallel with the ground or floor of a building.

To use the spacer device 10 of the present invention, one or more of the spacers 12, 14, 16 can be peeled away from the remaining spacers 12, 14, 16 by simply lifting the number of spacers 12, 14, 16 desired, and tearing the backing portion 18. Each spacer 12, 14, 16 can be removed individually, or in groups. The number of spacers 12, 14, 16 can be chosen based on the spacing between the wall 28 and the frame 20.

For example, two of the first spacers 12 could be used between the upper frame member 24 and the top 32 of the wall 28, where only a small amount of space is between the wall 28 and the frame 20. Also, if a greater amount of space exists between the wall 28 and the frame 20, such as when looking at the side frame member 22 and the side 30 of the wall 28 on the right side of FIG. 2, then two spacers 12,14 can be used. A greater or lesser number of spacers 12, 14, 16 can be used, depending upon the amount of space between the wall 28 and the frame 20.

Additionally, if the space between the wall 28 and the frame 20 is not even, for example the side 30 of the wall 28 seen toward the left of FIG. 2, different amounts of spacers 12, 14, 16 can be used in different locations to allow the part of the frame 20 to be positioned as desired. When looking at FIG. 2, two spacers 12, 14 have been used in one location, and three spacers 12, 14, 16 have been used in another location. This will allow for the side frame member 22 on the left side of FIG. 1 to be perpendicular with the floor or ground of the structure being built, even if the side 30 of the wall 28 on the left side of FIG. 2 is not perpendicular to the floor or ground of the structure being built.

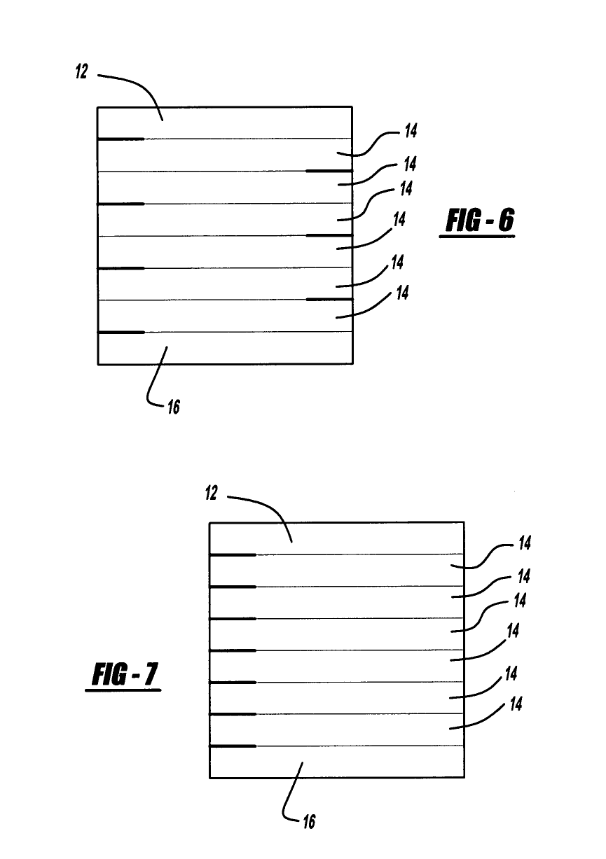

As shown in FIGS. 6 and 7, the backing portion 18 is an adhesive which is placed on a portion of one side of each of the spacers 12, 14, 16. In FIG. 6, the backing portion 18 is staggered, and in FIG. 7, the backing portion 18 is not staggered. When using a spacer device 10 as shown in FIGS. 6 or 7, one or more of the spacers 12, 14, 16 can be removed, and the adhesive on the spacer 12, 14, 16 exposed after removal can be used for temporary attachment to the frame 20, until a fastener can be used for providing a more permanent connection.

The spacers 12, 14, 16 of the present invention can be attached to the wall 28 in any number of ways, through the use of a variety of fasteners. The fasteners could be a screw, an adhesive such as glue, nails, or the like.

Another feature of the present invention is that the spacers 12, 14, 16 can be made of various materials. The spacers 12, 14, 16 can be made from materials such as cardboard, plastic, wood, metal, or any other type of material suited for a specific application. The spacers 12, 14, 16 can be treated such that they are not effected by various weather conditions when used for a frame 20 that will be exposed to various weather conditions. The width, designated generally at 34, of the spacers 12, 14, 16, is less than that of the frame members 22, 24, 26 used for constructing a building. The frame members 22, 24, 26 used for constructing a building typically have a width of four inches. The spacers 12, 14, 16 can be used for a frame 20 that can be a door frame, a window frame, or any other type of frame, regardless of the shape of the frame, used in the construction of a building.

Each of the spacers 12, 14 also includes an access portion, which in the embodiment shown is an angled portion 36. The angled portion 36 is located on the opposite side of each of the spacers 12, 14 in relation to the backing portion such that the desired number of spacers 12, 14 can be selected and removed. Also, each angled portion 26 of the spacers 12, 14 is staggered, as shown in FIGS. 1 and 2, to further improve the desired number of spacers 12, 14, 16 to be selected and removed from the backing portion 18.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A spacer device, comprising:
at least one spacer selectively connected to an end spacer by a backing portion; and
said first spacer is selectively removable from said end spacer by severing said backing portion.

2. The spacer device of claim 1, said at least one spacer further comprising:
at least one middle spacer located between said at least one spacer and said end spacer; and
said backing portion selectively connects said at least one spacer, said at least one middle spacer, and said end spacer.

3. The spacer device of claim 1, said backing portion further comprising an adhesive for holding said at least one spacer and said end spacer together.

4. The spacer device of claim 3, wherein said adhesive of said backing portion is located on a portion of one side of each of said at least one spacer and said end spacer.

5. The spacer device of claim 4, wherein said adhesive of said backing portion is in a staggered configuration on each of said at least one spacer and said end spacer.

6. The spacer device of claim 1, wherein said at least one spacer and said end spacer are die-cut such that a portion of each of said at least one spacer and said end spacer form said backing portion, and said at least one spacer is separated from said end spacer by severing said backing portion.

7. The spacer device of claim 1, wherein said at least one spacer and said end spacer are connected by a fastener.

8. The spacer device of claim 7, said fastener is selected from the group consisting of a screw, a rivet, a nut and bolt, or a bonding agent.

9. The spacer device of claim 1, each of said at least one spacer and said end spacer further comprising an access portion, said access portion located on the opposite side of each of said at least one spacer and said end spacer in relation to said backing portion.

10. The spacer device of claim 9, said access portion further comprising an angled portion formed on at least one of said at least one spacer and said end spacer.

11. A spacer device, comprising:
a first spacer adjacent to at least one middle spacer;
an end spacer adjacent to said at least one middle spacer; and
a backing portion for selectively connecting said first spacer, said at least one middle spacer, and said end spacer.

12. The spacer device of claim 11, said backing portion further comprising an adhesive.

13. The spacer device of claim 12, said adhesive of said backing portion is located on a portion of one side of each of said first spacer, said at least one middle spacer, and said end spacer.

14. The spacer device of claim 13, wherein said adhesive of said backing portion is located in a staggered configuration on said first spacer, said at least one middle spacer, and said end spacer.

15. The spacer device of claim 11, wherein said first spacer, said at least one middle spacer, and said end spacer are die-cut such that a portion of each of said first spacer, said at least one middle spacer, and said end spacer forms said backing portion.

16. The spacer device of claim 11, wherein each of said first spacer, said at least one middle spacer, and said end spacer are connected to a structure and at least one frame member by a fastener, and said fastener is one selected from the group consisting of a screw, a rivet, a nut and bolt, or a bonding agent.

17. The spacer device of claim 11, further comprising a number of spacers selected from said first spacer, said at least one middle spacer, and said end spacer, where the number of spacers selected from said first spacer, said at least one middle spacer, and said end spacer can be removed by severing said backing portion attached to said number of spacers selected from the remaining portion of said backing portion.

18. The spacer device of claim 11, further comprising an angled portion formed into each of said first spacer and said at least one middle spacer.

19. A method for aligning multiple frame members which are attached to a structure using a spacer device, comprising the steps of:
providing a first spacer selectively connected to a plurality of middle spacers;
providing an end spacer selectively connected to said plurality of middle spacers;
providing at least one frame member selectively connected to one or more of said first spacer, said plurality of middle spacers, or said end spacer;
selectively connecting said first spacer, said plurality of middle spacers, and said end spacer by using a backing portion; and
connecting said at least one frame member to a structure using one or more of said first spacer, said plurality of middle spacers, and said end spacer.

20. The method for aligning multiple frame members which are attached to a structure using a spacer device of claim 19, further comprising the steps of providing said structure further to be comprised of a wall.

21. The method for aligning multiple frame members which are attached to a structure using a spacer device of claim 19, further comprising the steps of providing said backing portion to be comprised of an adhesive material.

22. The method for aligning multiple frame members which are attached to a structure using a spacer device of claim 21, further comprising the steps of:
locating said adhesive material on a portion of one side of each of said first spacer, said plurality of middle spacers, and said end spacer;
selecting a desired number of said first spacer, said plurality of middle spacers, and said end spacers; and
connecting said desired number of said first spacer, said plurality of middle spacer, and said end spacer to said structure using said adhesive material.

23. The method for aligning multiple frame members which are attached to a structure using a spacer device of claim 22, further comprising the steps of staggering the location of said adhesive material on said first spacer, said plurality of middle spacers, and said end spacer.

24. The method for aligning multiple frame members which are attached to a structure using a spacer device of claim 19, further comprising the steps of die-cutting said first spacer, said plurality of middle spacers, and said end spacer such that a portion of each of said first spacer, said plurality of middle spacers, and said end spacer form at least a portion of said backing portion.

25. The method for aligning multiple frame members which are attached to a structure using a spacer device of claim 19, further comprising the steps of:
selecting a desired position of said at least one frame member relative to said structure;
selecting one or more of said first spacer, said plurality of middle spacers, and said end spacer; and
connecting said upper frame member to said structure with at least one of said first spacer, said plurality of middle spacers, and said end spacer such that when said upper frame member is connected to said one or more of said first spacer, said plurality of middle spacers, and said end spacer, said upper frame member will be in said desired position.

26. The method for aligning multiple frame members which are attached to a structure using a spacer device of claim 19, further comprising the steps of providing said at least one frame member to be comprised of:
providing an upper frame member;
providing at least one side frame member in proximity to said upper frame member;
providing a lower frame member in proximity to said at least one side frame member;
using one or more of said first spacer, said plurality of middle spacers, and said end spacer to connect said upper frame member to said structure;
using one or more of said first spacer, said plurality of middle spacers, and said end spacer to connect said upper frame member to said structure; and
using one or more of said first spacer, said plurality of middle spacers, and said end spacer to connect said upper frame member to said structure.

27. The method for aligning multiple frame members which are attached to a structure using a spacer device of claim 19, further comprising the steps of:
connecting said first spacer, said plurality of middle spacers, and said end spacer to said upper frame member, said lower frame member, said at least one side frame member, and said structure by a fastener; and
selecting said fastener from the group consisting of a screw, a rivet, a nut and bolt, or a bonding agent.

28. The method for aligning multiple frame members which are attached to a structure using a spacer device of claim 19, further comprising the steps of providing an angled portion formed as a portion of each of said first spacer and said plurality of middle spacers.
